(19) United States
(12) Patent Application Publication
(10) Pub. No.: US 2022/0337734 A1
(43) Pub. Date: Oct. 20, 2022

(54) IMAGE-CAPTURING CONTROL SYSTEM, CONTROL DEVICE, AND NON-TRANSITORY COMPUTER-READABLE MEDIUM

(71) Applicant: KABUSHIKI KAISHA TOKAI RIKA DENKI SEISAKUSHO, Aichi (JP)

(72) Inventors: Kenji NARUMI, Aichi (JP); Mitsuo MORI, Aichi (JP)

(73) Assignee: KABUSHIKI KAISHA TOKAI RIKA DENKI SEISAKUSHO, Aichi (JP)

(21) Appl. No.: 17/636,213

(22) PCT Filed: Jul. 29, 2020
(86) PCT No.: PCT/JP2020/029128

§ 371 Date: Feb. 17, 2022

(30) Foreign Application Priority Data
Aug. 23, 2019 (JP) 2019-153007

(51) Int. Cl. H04N 5/235; H04N 5/225; G03B 17/18

(52) U.S. Cl. CPC H04N 5/2352; H04N 5/2256; G03B 17/18

(57) ABSTRACT

A control device controls an image capturing device installed in a wearable device. A display device is capable of communicating with the control device. The control device is configured to: cause the display device to display a plurality of candidate images corresponding to images of a subject captured with different exposure conditions; detect a selection of one of the candidate images; and cause the image capturing device to capture an image of the subject with an exposure condition corresponding to the one of the candidate images as selected.

### FIELD

The presently disclosed subject matter relates to a control device configured to control an image capturing device installed in a wearable device, and an image-capturing control system including a display device capable of communicating with such a control device. The presently disclosed subject matter also relates to the control device, and a non-transitory computer-readable medium having recorded a computer program executable by the control device.

### BACKGROUND

Japanese Patent Publication No. 2008-167299A discloses an apparatus for capturing an image of a subject while changing exposure conditions as required.

### SUMMARY

### Technical Problem

It is demanded to make it easy to obtain a desired image-capturing result even in a situation that the image-capturing condition is easily changed.

### Solution to Problem

In order to meet the demand described above, an illustrative aspect of the presently disclosed subject matter provides an image-capturing control system, comprising:

a control device configured to control an image capturing device installed in a wearable device; and

a display device capable of communicating with the control device,

wherein the control device is configured to:
cause the display device to display a plurality of first candidate images corresponding to images of a subject captured with different exposure conditions;
detect a selection of one of the first candidate images; and
cause the image capturing device to capture an image of the subject with a first exposure condition corresponding to the one of the first candidate images as selected.

In order to meet the demand described above, an illustrative aspect of the presently disclosed subject matter provides a control device configured to control an image capturing device installed in a wearable device and capable of communicating with a display device, the control device being configured to:

cause the display device to display a plurality of first candidate images corresponding to images of a subject captured with different exposure conditions;

detect a selection of one of the first candidate images; and

cause the image capturing device to capture an image of the subject with a first exposure condition corresponding to the one of the first candidate images as selected.

In order to meet the demand described above, an illustrative aspect of the presently disclosed subject matter provides a non-transitory computer-readable medium having stored a computer program to be executed by a control device configured to control an image capturing device installed in a wearable device and capable of communicating with a display device, the computer program being configured to, when executed, cause the control device to:

cause the display device to display a plurality of first candidate images corresponding to images of a subject captured with different exposure conditions;

detect a selection of one of the first candidate images; and

cause the image capturing device to capture an image of the subject with a first exposure condition corresponding to the one of the first candidate images as selected.

The first candidate images are images of the subject acquired while changing the exposure condition under an image-capturing environment that the user wearing the wearable device is currently placed. The user can prepare the first candidate images displayed on the display device with different appearances to select one candidate image that exhibits an optimal appearance, thereby setting an optimal exposure condition for capturing an image of the subject in the environment corresponding to the selected candidate image. Since it is possible to make an intuitive selection based on the comparison of the images having different appearances, it is unnecessary to have expert knowledge as for the setting of the exposure condition. Accordingly, even in a situation that the image-capturing condition is easily changed, a desired image-capturing result can be easily obtained.

### BRIEF DESCRIPTION OF DRAWINGS

FIG. 1 illustrates a functional configuration of an image-capturing control system according to an embodiment.

FIG. 2 illustrates an exemplary operation flow of the image-capturing control system of FIG. 1.

FIG. 3 illustrates candidate images to be displayed on a display device of FIG. 1.

FIG. 4 illustrates another exemplary operation flow of the image-capturing control system of FIG. 1.

FIG. 5 illustrates a vehicle in which a display device according to another example is to be installed.

FIG. 6 illustrates another exemplary operation flow of the image-capturing control system of FIG. 1.

### DESCRIPTION OF EMBODIMENTS

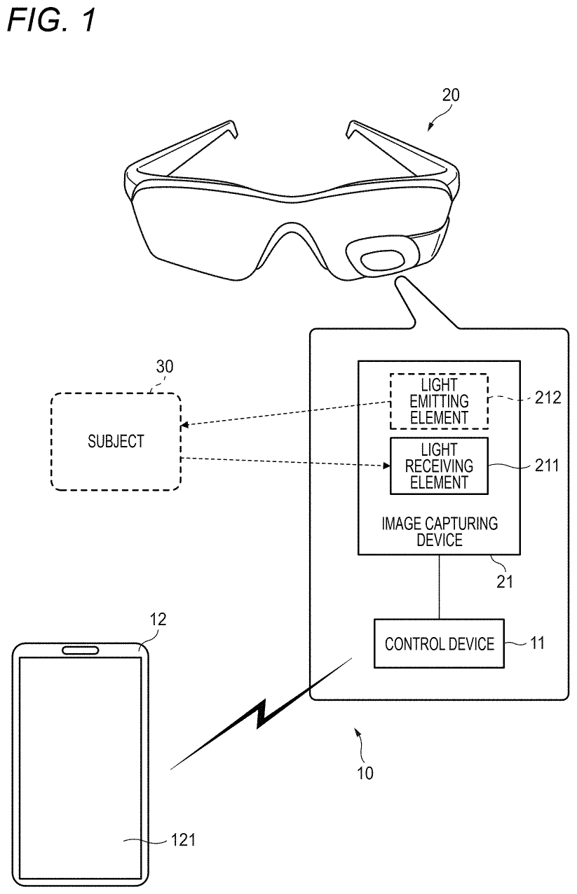

Exemplary embodiments will be described in detail below with reference to the accompanying drawings. FIG. 1 illustrates a functional configuration of an image-capturing control system 10 according to an embodiment.

The image-capturing control system 10 includes a control device 11 and a display device 12. The control device 11 is a device configured to control an image capturing device 21 installed in a wearable device 20. The display device 12 includes a screen 121 capable of displaying information including texts and images. The display device 12 is a device capable of communicating with the control device 11 based on an appropriate communication standard. In other words, the control device 11 includes a communication interface capable of communicating with the display device 12 based on the communication standard. The communication may be performed via a wired connection or a wireless connection.

The wearable device 20 is a device adapted to be worn by a user in order to acquire desired information. The wearable device 20 may take the form of spectacles, goggles, hats, helmets, accessories, and the like.

The image capturing device 21 is a device configured to acquire an image of a subject 30 as the above-described desired information. The image capturing device 21 includes a light receiving element 211. Examples of the light receiving element 211 include a CCD image sensor and a CMOS image sensor each of which is sensitive to visible light, as well as a thermal infrared detector that is sensitive to infrared light.

The image capturing device 21 can capture an image of the subject 30 with different exposure conditions. The exposure condition can be changed by adjusting at least one of an illumination intensity and a shutter speed. The image capturing device 21 may be equipped with a light emitting element 212 configured to emit illumination light to the subject 30 as required. The illumination intensity can be changed by adjusting the intensity of the illumination light. The shutter speed can be changed by adjusting a time length for allowing the light receiving element 211 to receive light coming from the subject 30.

The adjustment of these parameters is performed by a control signal outputted from the control device 11. Accordingly, the control device 11 includes an output interface configured to output the control signal to the image capturing device 21. The control signal may be a digital signal or an analog signal. When the control signal is an analog signal, the output interface includes an appropriate conversion circuit including a D/A converter.

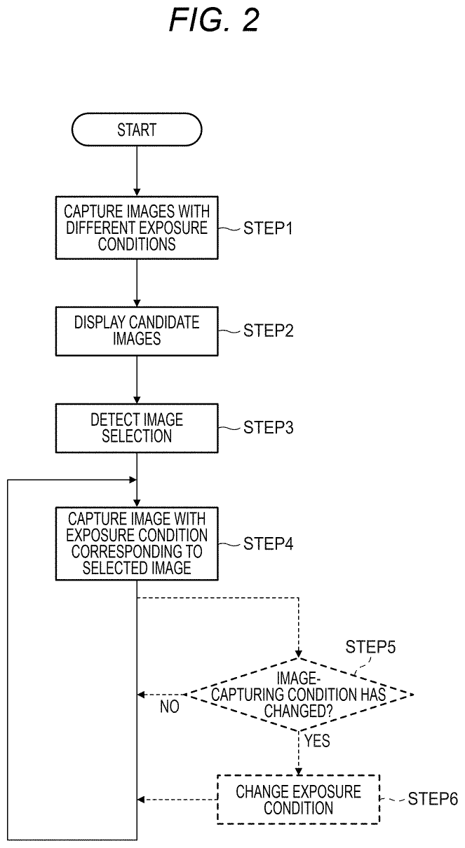

FIG. 2 illustrates a flow of processing to be executed by the image-capturing control system 10. In this example, a goggle-type wearable device 20 is attached on a head of a user, so that an image of an eye of the user is captured by the image capturing device 21 as the subject 30. The image of the user's eye can be used, for example, to detect a line of sight or an arousal level of the user. In this example, a portable information terminal is used as the display device 12.

First, in STEP1, the control device 11 causes the image capturing device 21 to capture images of the subject 30 under different exposure conditions. Specifically, the control device 11 outputs a control signal for causing the image capturing device 21 to capture images while changing at least one of the illumination intensity and the shutter speed. As a result, a plurality of images of the subject 30 captured under different exposure conditions are acquired.

Subsequently, the control device 11 transmits image data corresponding to the images of the subject 30 acquired in STEP1 to the display device 12 through the communication interface described above. The display device 12 displays, based on the received image data, the images of the subject 30 as a plurality of first candidate images on the screen 121 (STEP2).

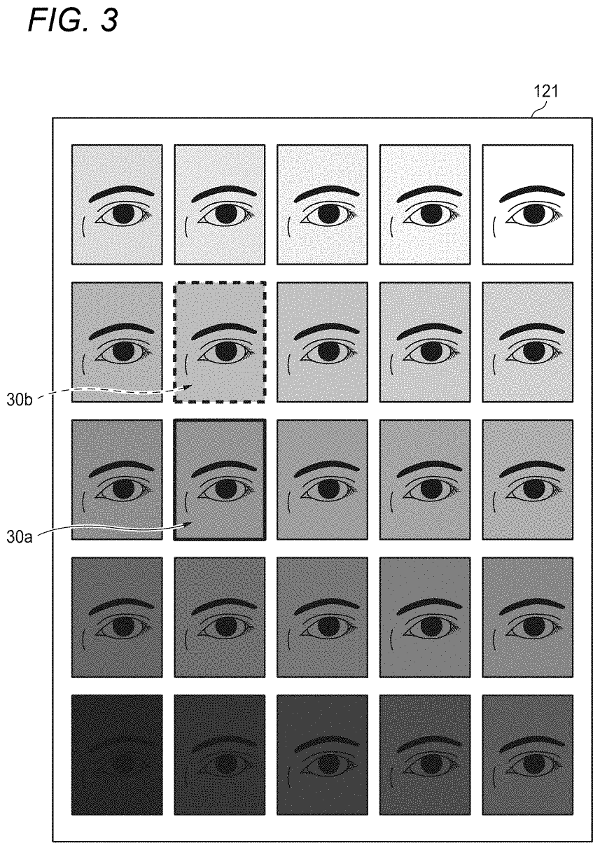

FIG. 3 illustrates a plurality of first candidate images displayed on the screen 121. Each candidate image is assigned with one of the exposure conditions different from each other applied when the image capturing of STEP1 is performed. Accordingly, the appearances of the first candidate images are different from each other.

Subsequently, the user selects one of the first candidate images as displayed. For example, the user inputs, to the display device 12, an operation for selecting one candidate image that is considered to be optimally captured from the first candidate images having different appearances. FIG. 3 illustrates an example wherein a candidate image 30a in the third row from the top and the second column from the left is selected. The display device 12 transmits selection result data corresponding to the selected result to the control device 11. The control device 11 receives the selection result data through the communication interface, and detects that a particular candidate image is selected (STEP3 in FIG. 2).

Subsequently, the control device 11 sets an exposure condition associated with the selected candidate image as a first exposure condition. The control device 11 outputs a control signal, through the above-described output interface, for causing the image capturing device 21 to capture an image of the subject 30 under the first exposure condition (STEP4). The image capturing device 21 having received the control signal adjusts at least one of the illumination intensity and the shutter speed so as to satisfy the first exposure condition, and starts capturing an image of the subject 30. The image capturing of the subject 30 based on the first exposure condition is repeated every time when a prescribed time length elapses.

The first candidate images are images of the subject 30 acquired while changing the exposure condition under an image-capturing environment that the user wearing the wearable device 20 is currently placed. The user can prepare the first candidate images displayed on the display device 12 with different appearances to select one candidate image that exhibits an optimal appearance, thereby setting an optimal exposure condition for capturing an image of the subject 30 in the environment corresponding to the selected candidate image. Since it is possible to make an intuitive selection based on the comparison of the images having different appearances, it is unnecessary to have expert knowledge as for the setting of the exposure condition. Accordingly, even in a situation that the image-capturing condition is easily changed, a desired image-capturing result can be easily obtained.

The control device 11 acquires data corresponding to the image of the subject 30 captured with the first exposure condition described above from the image capturing device 21 as first image data. Subsequently, after a prescribed time length elapses, the control device 11 can acquire data corresponding to the image of the subject 30 captured with the first exposure condition described above from the image capturing device 21 as second image data. In other words, the second image data corresponds to an image of the subject 30 obtained by the image capturing based on the first exposure condition that is performed after the acquisition of the first image data.

Accordingly, the control device 11 includes an input interface for receiving the first image data and the second image data from the image capturing device 21. The first image data and the second image data may be in the form of digital data, or may be in the form of analog data. In a case where the first image data and the second image data are in the form of analog data, the input interface includes an appropriate conversion circuit including an A/D converter.

In this case, the control device 11 may be configured to perform processing for detecting a difference between the first image data and the second image data. Specifically, first luminance data indicating a luminance of one of pixels constituting an image corresponding to the first image data and second luminance data indicating a luminance of a corresponding one of pixels constituting an image corresponding to the second image data are compared. The comparison is performed for a plurality of pixels that are at least a portion of all the pixels.

The comparison processing may be performed to determine whether the image-capturing condition has changed (STEP5 in FIG. 2). Specifically, the control device 11 can determine whether a ratio of the number of pixels having the second luminance data in which the difference from the first luminance data exceeds a threshold value to the number of all pixels subjected to the comparison exceeds a first threshold value. When it is determined that the ratio does not exceed the first threshold value (NO in STEP5), a next second image data is acquired after a prescribed time length elapses to repeat the above comparison (STEP4).

When it is determined that the ratio exceeds the first threshold value (YES in STEP5), the control device 11 performs processing for changing the first exposure condition (STEP6). Specifically, at least one of the illumination intensity and the shutter speed is changed so that the difference between the first image data and the second image data is reduced.

For example, when the brightness of external light is increased, the state of an image of the subject 30 to be captured with the first exposure condition may be changed from the state of the selected candidate image 30a to the state of a candidate image 30b surrounded by dashed lines in FIG. 3. When this change is detected, the control device 11 changes the first exposure condition so as to increase the shutter speed.

According to such a configuration, once the first exposure condition for obtaining a desired image-capturing result is set, even if the image-capturing condition changes after the initiation of the image capturing, the acquisition of the desired image-capturing result can be still obtained. Accordingly, even in a situation that the image-capturing condition is easily changed, obtaining of a desired image-capturing result can be facilitated.

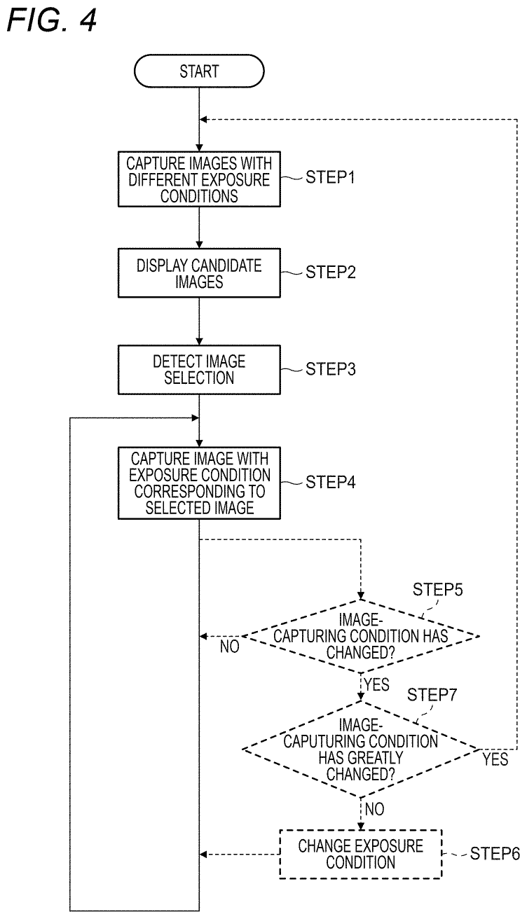

FIG. 4 illustrates another example of the flow of processing to be executed by the control device 11. Processing elements substantially the same as those in the example illustrated in FIG. 2 are assigned with the same reference numerals, and repetitive descriptions for those will be omitted.

In this example, in a case where it is determined that the ratio of the number of pixels having the second luminance data in which the difference from the first luminance data exceeds the threshold value to the number of all the pixels subjected to the comparison exceeds the first threshold value (YES in STEP5), the control device 11 performs processing for determining whether the ratio exceeds a second threshold value. The second threshold value is greater than the first threshold value. In other words, the control device 11 determines whether the change in the image-capturing condition is greater than a prescribed degree (STEP7).

In a case where it is determined that the ratio exceeds the first threshold value but does not exceed the second threshold value (NO in STEP7), the control device 11 changes the first exposure condition as a response to the change in the image-capturing condition (STEP6).

In a case where it is determined that the ratio exceeds the second threshold value (YES in STEP7), the control device 11 returns the processing to STEP1. In other words, the control device 11 causes the image capturing device 21 to capture images of the subject 30 with different exposure conditions. As a result, a plurality of images of the subject 30 captured with the different exposure conditions under a new image-capturing condition are acquired.

Subsequently, the control device 11 transmits image data corresponding to the images of the subject 30 acquired in STEP1 to the display device 12 through the communication interface described above. Based on the received image data, the display device 12 displays a plurality of images of the subject 30 as a plurality of second candidate images on the screen 121 (STEP2).

In brief, the user is requested to reset the exposure condition. Upon the display of the second candidate images, it is preferable to notify the user of the need to reset the exposure condition. The notification may be made through at least one of a visual notification, an audio notification, and a tactile notification.

As in the case of the first candidate images, the user selects one of the second candidate images as displayed. The display device 12 transmits selection result data corresponding to the selected result to the control device 11. The control device 11 receives the selection result data through the communication interface, and detects that a particular candidate image is selected (STEP3).

Subsequently, the control device 11 performs processing for setting an exposure condition associated with the selected candidate image as a second exposure condition. The control device 11 outputs a control signal, through the above-described output interface, for causing the image capturing device 21 to capture an image of the subject 30 under the second exposure condition (STEP4). The image capturing device 21 having received the control signal adjusts at least one of the illumination intensity and the shutter speed so as to satisfy the second exposure condition, and starts capturing an image of the subject 30. The image capturing of the subject 30 based on the second exposure condition is repeated every time when a prescribed time length elapses.

The change in the image-capturing condition is not limited to a change in the amount of external light. Since the image capturing device 21 is installed in the wearable device 20, the subject 30 may be displaced from the initial image-capturing position due to the displacement of the wearable device 20 attached to the user's body. In such a case, the difference between the first image data and the second image data increases. In other words, a desired image-capturing result cannot be obtained with the initial exposure condition.

According to the configuration as described above, in a case where a major change occurs in the image-capturing result due to major change in the amount of external light, a positional deviation of the wearable device 20, or the like, it is required for the user to reset the exposure condition. As a result, even if the image-capturing condition greatly changes after the initiation of the image capturing, the exposure condition is reset such that a desired image-capturing result is obtained under the image-capturing condition as changed. Accordingly, even in a situation that the image-capturing condition is easily changed, a desired image-capturing result can be still obtained.

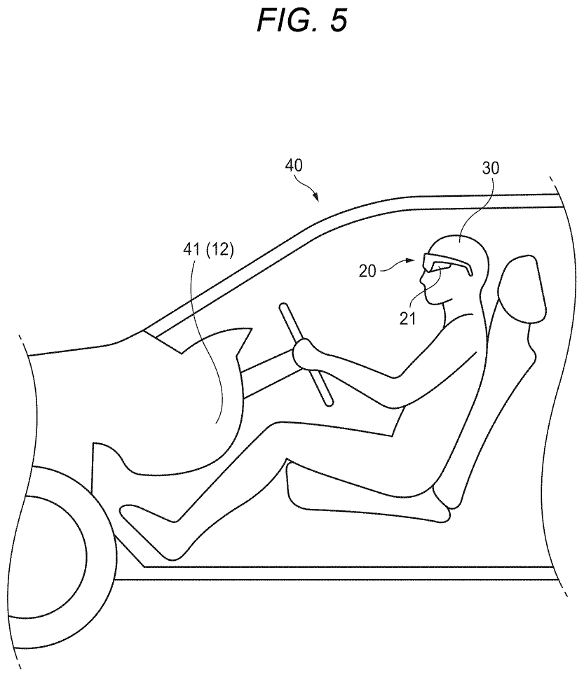

The display device 12 may be a device installed in a vehicle 40 as illustrated in FIG. 5. For example, the display device 12 may be disposed in a center cluster 41 of the vehicle 40. The vehicle 40 is an example of a mobile entity. In this case, the subject 30 is an occupant of the vehicle 40.

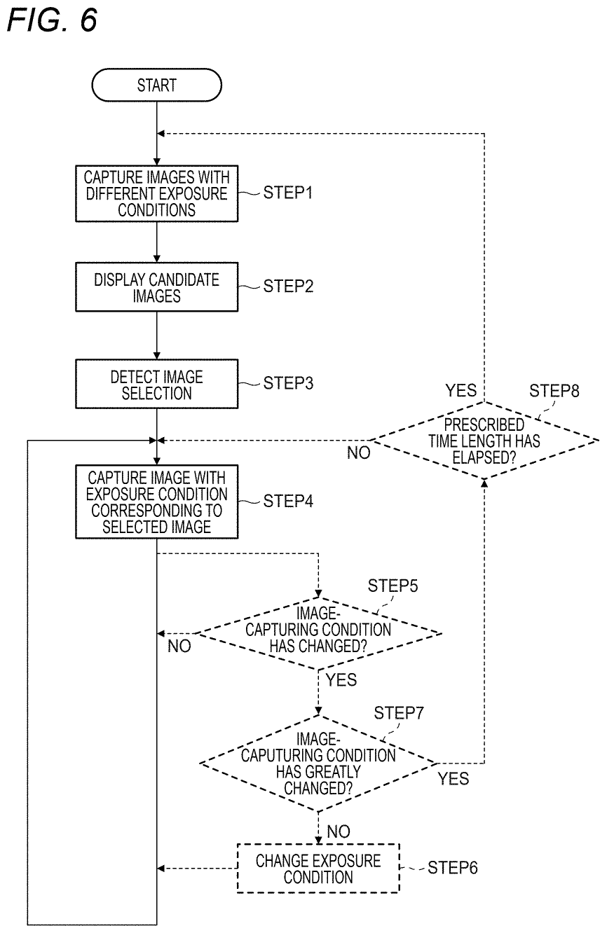

FIG. 6 illustrates an example of processing to be executed by the control device 11 in a case where the display device 12 is adapted to be installed in a vehicle. Processing elements substantially the same as those in the example illustrated in FIG. 4 are assigned with the same reference numerals, and repetitive descriptions for those will be omitted.

In this example, when it is determined that the change in the image-capturing condition is greater than the prescribed degree (YES in STEP7), the control device 11 starts clocking. In addition, in STEP8, the control device 11 performs processing for determining whether a prescribed time length has elapsed since the start of the clocking. When it is determined that the prescribed time length has not elapsed (NO in STEP8), the processing returns to STEP4, a next second image data is acquired to repeat the determination as for the change in the image-capturing condition (STEP5, STEP7).

When it is determined that the prescribed time length has elapsed (YES in STEP8), the control device 11 returns the processing to STEP1. In other words, in a case where a prescribed time length elapses while it is determined that the change in the image-capturing condition is greater than the prescribed degree, the control device 11 performs processing for requesting the user to reset the exposure condition.

While the vehicle 40 is traveling, major change tends to occur in the image-capturing condition in accordance with the passage of a tunnel, shadows of buildings or transportation facilities, and the like. On the other hand, such a change in the image-capturing condition is often transitory. Accordingly, the occupant as the subject 30 would feel burdensome if the reset of the exposure condition is requested every time when the image-capturing condition greatly changes. According to the configuration as described above, the reset of the exposure condition is requested in a case where a relatively great change occurs in the image-capturing condition due to change in weather, between daytime and nighttime or the like, but such change is transitory. Accordingly, even when the user is in the vehicle at which the image-capturing condition is easily changed, a desired image-capturing result can be obtained continuously.

It should be noted that in a case where the portable information terminal illustrated in FIG. 1 is brought into the vehicle 40 as the display device 12, an operation mode for executing the processing illustrated in FIG. 6 may be initiated.

In the example illustrated in FIG. 3, a plurality of candidate images captured with different exposure conditions are two-dimensionally arranged on a plane. The exposure condition is changed by adjusting each of the illumination intensity and the shutter speed of the image capturing device 21. The lateral direction corresponds to the change in the illumination intensity. The illumination intensity increases from left to right. The longitudinal direction corresponds to the change in the shutter speed. The shutter speed increases from top to bottom. The lateral direction is an example of a first direction included in the plane. The vertical direction is an example of a second direction included in the plane.

According to such a configuration, even if the user has no expert knowledge about two parameters that can be adjusted in order to change the exposure condition, it is possible to intuitively compare the image-capturing results that may be different from each other in accordance with the change in the exposure condition. It is possible to set an exposure condition for obtaining a desired image-capturing result by merely selecting a specific candidate image as a result of the comparison. Accordingly, it is possible to provide a user interface capable of easily obtaining a desired image-capturing result even in a situation that the image-capturing condition is easily changed.

As long as the image-capturing results that may be different from each other due to the change in the exposure condition can be intuitively compared, it is possible to appropriately determine how the first candidate images and the second candidate images are presented by the display device 12. In a case where either the illumination intensity or the shutter speed is changed in order to change the exposure condition, the candidate images may be arranged linearly or annularly. The direction in which they are linearly arranged may be arbitrarily determined.

The image capturing device 21 may be an infrared camera configured to perform the image capturing by irradiating an infrared light to a subject 30 and receiving infrared light coming from the subject 30.

According to such a configuration, it is possible to satisfactorily acquire an image of the subject 30 even in a dark room or at night. On the other hand, the image capturing device 21 may be susceptible to disturbances such as sunlight. However, even in a situation that the image-capturing condition is easily changed as described above, it is possible to set the exposure condition under which a desired image-capturing result is obtained through the presentation of a plurality of candidate images. In particular, since the appearance of the image acquired by the infrared camera is different from the appearance of the image acquired by the visible light camera, there is a great advantage in that a plurality of candidate images are subjected to an intuitive comparison.

The various types of processing executed by the control device 11 described above can be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the various types of processing can be stored in the ROM. The ROM is an example of a non-transitory computer-readable medium having recorded a computer program. The control device 11 designates at least a part of the program stored in the ROM, loads the program on the RAM, and executes the various types of processing in cooperation with the RAM. The above-described computer program may be pre-installed in a general-purpose memory, or may be downloaded from an external server device via a communication network and then installed in the general-purpose memory. In this case, the external server device is an example of the non-transitory computer-readable medium.

The various types of processing executed by the control device 11 may be implemented by an exclusive integrated circuit such as a microcontroller, an ASIC, and an FPGA. In this case, a computer program for executing the various types of processing is pre-installed in a storage element included in the exclusive integrated circuit. The memory element is an example of a non-transitory computer-readable medium. The various types of processing executed by the control device 11 may be implemented by a combination of the general-purpose microprocessor and the exclusive integrated circuit.

The above embodiments are merely illustrative for facilitating understanding of the gist of the presently disclosed subject matter. The configuration according to each of the above embodiments can be appropriately modified or changed without departing from the gist of the presently disclosed subject matter.

In the above embodiment, a plurality of candidate images are displayed on the display device 12, and the display device 12 receives an instruction to select one candidate image. However, the instruction for selecting one candidate image may be received through an appropriate device such as the wearable device 20 or a switch installed in a vehicle.

The subject 30 to be subjected to the image capturing performed by the image capturing device 21 installed in the wearable device 20 need not be the eye of the user wearing the wearable device 20. However, the above-described image-capturing control system 10 is particularly useful in a case where the subject 30 is a portion that is not directly visible by a user wearing the wearable device 20.

The subject 30 wearing the wearable device 20 need not be a driver of the vehicle 40. Other occupants may also become the subject 30 by wearing the wearable device 20.

The mobile entity carrying the subject 30 is not limited to the vehicle 40. Examples of other mobile entities include railways, ships, and aircrafts.

The present application is based on Japanese Patent Application No. 2019-153007 filed on Aug. 23, 2019, the entire contents of which are incorporated herein by reference.

1. An image-capturing control system, comprising:
a control device configured to control an image capturing device installed in a wearable device; and
a display device capable of communicating with the control device,
wherein the control device is configured to:
cause the display device to display a plurality of first candidate images corresponding to images of a subject captured with different exposure conditions;
detect a selection of one of the first candidate images; and
cause the image capturing device to capture an image of the subject with a first exposure condition corresponding to the one of the first candidate images as selected.

2. The image-capturing control system according to claim 1,
wherein the control device is configured to:
acquire first image data corresponding to the image of the subject captured with the first exposure condition;
acquire second image data corresponding to the image of the subject captured by an image capturing with the first exposure condition that is performed after the first image data is acquired;
detect a difference between the first image data and the second image data; and
change the first exposure condition so as to reduce the difference.

3. The image-capturing control system according to claim 2,
wherein in a case where the difference exceeds a threshold value, the control device is configured to:
cause the display device to display, based on the second image data, a plurality of second candidate images corresponding to images of the subject captured with different exposure conditions;
detect a selection of one of the second candidate images; and
cause the image capturing device to capture an image of the subject with a second exposure condition corresponding to the one of the second candidate images as selected.

4. The image-capturing control system according to claim 3,
wherein the display device is a device installed in a mobile entity; and
wherein the control device is configured to cause the display device to display the second candidate images in a case where a prescribed time length elapses while the difference exceeds the threshold value.

5. The image-capturing control system according to claim 1,
wherein the different exposure conditions are set by changing at least one of an illumination intensity and a shutter speed of the image capturing device; and
wherein the display device is configured to arrange the first candidate images two-dimensionally on a plane including a first direction corresponding to the illumination intensity and a second direction corresponding to the shutter speed.

6. The image-capturing control system according to claim 1,
wherein the first candidate images are images captured by irradiating infrared light to the subject.

7. A control device configured to control an image capturing device installed in a wearable device and capable of communicating with a display device, the control device being configured to:
cause the display device to display a plurality of first candidate images corresponding to images of a subject captured with different exposure conditions;
detect a selection of one of the first candidate images; and
cause the image capturing device to capture an image of the subject with a first exposure condition corresponding to the one of the first candidate images as selected.

8. A non-transitory computer-readable medium having stored a computer program to be executed by a control device configured to control an image capturing device installed in a wearable device and capable of communicating with a display device, the computer program being configured to, when executed, cause the control device to:
cause the display device to display a plurality of first candidate images corresponding to images of a subject captured with different exposure conditions;
detect a selection of one of the first candidate images; and
cause the image capturing device to capture an image of the subject with a first exposure condition corresponding to the one of the first candidate images as selected.
